(19) United States
(12) Patent Application Publication
(10) Pub. No.: US 2024/0143999 A1
(43) Pub. Date: May 2, 2024

(54) MULTI-MODAL DATA PREDICTION METHOD BASED ON CAUSAL MARKOV MODEL

(71) Applicants: BEIHANG UNIVERSITY, Beijing (CN); Beijing Big Data Center, Beijing (CN); Xicheng Dist Bureau of Sci and Tech and Info Tech of Beijing Muni (Xicheng Dist Big Data Mgmt, Beijing (CN)

(72) Inventors: Pan DENG, Beijing (CN); Yu ZHAO, Beijing (CN); Lin ZHANG, Beijing (CN); Xiaofeng JIA, Beijing (CN); Yan LIU, Beijing (CN); Junting LIU, Beijing (CN); Mulan WANG, Beijing (CN)

(21) Appl. No.: 18/199,363

(22) Filed: May 19, 2023

(30) Foreign Application Priority Data
Nov. 1, 2022 (CN) 202211357946.4

(51) Int. Cl. G06N 3/08; G06N 3/0455

(52) U.S. Cl. CPC G06N 3/08; G06N 3/0455

(57) ABSTRACT

The present invention provides a multi-modal data prediction method based on a causal Markov model, belonging to the technical field of intelligent traffic technology; the method of the present invention includes: collecting regional data and multi-modal traffic data of a research region; taking the time position, the regional point of interest and the weather information as conditional feature variables; taking the regional attraction factor, the bicycle demand factor, the taxi demand factor, the bus demand factor and the traffic speed factor as physical concept variables; taking the bicycle traffic flow, the taxi traffic flow, the bus traffic flow and the regional speed as multi-modal traffic data observation variables, and describing the generation process of the multi-modal traffic flow by using a causal Markov process; solving the causal Markov process by using a neural network, and training a built neural network for the multi-modal traffic data observation.

### TECHNICAL FIELD

This invention generally relates to the technical field of intelligent traffic technology (mining and prediction of urban traffic spatio-temporal data), and more particularly, to a multi-modal data prediction method based on a causal Markov model.

### BACKGROUND

An urban traffic system is a multi-modal complex system formed by mutually associating and aggregating a plurality of subsystems. Various travel modes represent various travel means, such as by bicycles, taxis, buses and passenger cars. Its purpose is to meet a variety of travel requirements while providing a variety of selections for urban residents. With the improvement of city infrastructure and increase in consumption level, the number of vehicles in a city continuously increases, causing the urban traffic infrastructure and its associated management fail to meet the travel requirements of urban residents, resulting in serious urban traffic congestion. The conflict between the uneven distribution of travel demands and the insufficient road resources is a major reason for the traffic congestion. Therefore, a comprehensive analysis of the travel demands is the key to solve this problem. The multi-modal traffic flow is capable of accurately reflecting the travel demands and describing the health degree of a traffic system, which allows the relevant authorities to make traffic management strategies according to the traffic flow in different conditions, thereby ensuring a smooth traffic operation. Thus, a multi-modal traffic prediction is crucial for the urban traffic management, which provides a traffic guidance and important data support for making traffic management strategies.

The purpose of multimodal traffic prediction is to synchronously predict the future traffic of multiple transportation vehicles based on the input historical flow data. Presently, most conventional traffic prediction methods merely predict the traffic flow in a single mode, such as the bicycle traffic flow or road speed, etc. These methods merely achieve a partial observation of the traffic system, failing to reflect a real-world situation in real scenarios. Though these methods are used for various traffic predictions, each mode requires the building of a prediction model, which consumes a lot of resources while failing to form an end-to-end unified framework. In recent years, the multi-modal traffic joint prediction has gradually attracted the attention of researchers. These methods normally adopt the multi-modal traffic flow to expand the channel dimension of input features or fuse various modal traffic features in the model. The purpose is to implicitly extract the spatio-temporal relationship of the multi-modal traffic data. However, these methods are lack of the description of causal relationships. Moreover, the dimension expansion of data features introduces a large number of confounding factors instead of improving the predicting ability of the model, resulting in poor prediction effect.

Presently, conventional multi-modal traffic prediction methods excessively emphasize the spatio-temporal correlations in traffic data, ignoring physical concepts affecting the generation of traffic data and causal relationships among these concepts. Under different conditions, the spatio-temporal correlations are considered unstable and a spurious correlation may exist. FIG. 1(a) is a schematic diagram illustrating the street division of a region in Beijing, and the traffic flow near a hospital in the region is shown in FIG. 1(b). Under normal conditions, the taxi traffic flow and the bicycle traffic flow are similar, and at this point, the taxi traffic and the bicycle traffic have a relatively high correlation. This is because the demands for people to reach or leave a certain region during rush hours are consistent, and therefore, the traffic trends shown in the Figures are normally consistent. However, in rainy days, due to weather variations, the demand for bicycles reduces while the demand for taxis increases. At this point, the aforesaid two have opposite flow trends, indicating that a spurious correlation exists between the taxi traffic flow and the bicycle traffic flow under the influence of weather. In addition, there is a strong causal relationship between the regional attribute and the travel demand. As shown in FIGS. 1(b) and 1(c), a hospital is a point of interest, resulting in a higher travel demand in the region. Therefore, the traffic flow in different modes exhibit a significant morning peak and noon peak, and meanwhile, the regional traffic speed is always low. The vicinity of the Financial Street is mainly a work region, and the traffic flow in different modes exhibits a significant morning peak and evening peak. Finally, as shown in FIG. 1(c), the demand for taxis may affect the traffic speed. An excessive demand for taxis may lead to an increase in taxi flow, which in turn leads to a decrease in traffic speed on the road.

### SUMMARY

The basic reason for causing the variation of the multi-modal traffic flow lies in the physical concepts (the regional attraction factor, the demand factors of different traffic modes and the traffic speed factor) affecting the generation of the flow data and the causal relationship among these concepts. Moreover, paying excessive attention on the correlations may lead to unstable prediction result of the multi-modal traffic flow. Therefore, the present invention provides a multi-modal data prediction method based on a causal Markov model, which starts from the generation process of the multi-modal traffic flow and divides the core physical concepts affecting the generation of flow data into three groups: 1) the attraction factors of the region in different time periods, 2) the demand factors of different traffic modes selected under different conditions, and 3) the traffic speed factor affected by the number of road vehicles. According to the present invention, the causal representation of the physical concepts is learned from the conditional information and the multi-modal traffic data, and the causal relationship among the physical concepts is further explored, so that an accurate prediction of the multi-modal traffic flow is achieved.

The multi-modal data prediction method based on a causal Markov model of the present invention is used for predicting the multi-modal traffic flow, thereby allowing relevant authorities to make traffic management strategies according to the traffic flow in different conditions. The method of the present invention comprises the following steps:

Step 1: collecting the regional data and traffic data of a research region, and constructing a causal graph of a causal Markov process;

First, obtaining the regional division, regional point of interest information, weather information and multi-modal traffic data of a research region, wherein the multi-modal traffic data includes the shared bicycle order data, taxi order data, bus order data and road traffic speed data;

Subsequently, taking the time position information, the regional point of interest information and the weather information as conditional feature variables, and taking the regional attraction factor, the bicycle demand factor, the taxi demand factor, the bus demand factor and the traffic speed factor as physical concept variables;

Finally, constructing a causal graph of a causal Markov process, and taking the bicycle traffic flow, the taxi traffic flow, the bus traffic flow and the regional speed of the sub-regions as traffic data observation variables; generating physical concept variables at a current time step from conditional feature variables at a current time step and physical concept variables at a previous time step, and then predicting traffic data observation variables at the current time step; describing a generation process of multi-modal traffic data observation variables using a joint distribution of physical concept variables and traffic data observation variables, and decomposing the joint distribution into a prior distribution of physical concept variables and a generation distribution of traffic data observation variables; describing the process of extracting physical concept variables from conditional feature variables and multi-modal traffic data using the posterior distribution of physical concept variables;

Step 2: building a causal Markov model by using a neural network, and solving the causal Markov process;

The causal Markov model comprises a prior network, a posterior network, a causal propagation module and a generation network; the prior network learns the prior distribution of the physical concept variables in the traffic system by using the input conditional feature variables; the posterior network learns the variational posterior distribution of the physical concept variables by using the input conditional feature variables and the multi-modal traffic data, and obtains an approximately real posterior distribution of the physical concept variables; both the prior network and the posterior network comprise a graph gated recurrent unit and share a causal propagation module; the causal propagation module inputs a causal representation of the physical concept variables, propagates the causal effect by using a learnable causal graph, and outputs a causal representation of the physical concept variables after the causal effect is propagated; the generation network inputs a causal representation of physical concept variables and outputs corresponding multi-modal traffic data observation variables;

Step 3: collecting historical data in a research region to train the causal Markov model, arranging the trained model on a traffic management system, and predicting the future bicycle traffic flow, taxi traffic flow, bus traffic flow and regional speed according to the historical bicycle traffic flow, taxi traffic flow, bus traffic flow and regional speed of each sub-region, thereby pre-warning the road congestion and assisting relevant authorities to make corresponding traffic management strategies.

Compared with the prior art, the present invention has the following advantages:
1) Differing from a conventional multi-modal traffic prediction method which pays excessive attention to spatio-temporal correlations, the method of the present invention starts from the generation of the multi-modal traffic flow, defines variables existing in a traffic system, constructs a causal graph among different variables, describes a generation process of the multi-modal traffic flow by using a causal Markov process, and provides a generation process of the modelling data of the causal Markov model; the present invention is capable of effectively inferring a causal representation of physical concepts affecting the generation of multi-modal traffic data from conditional information and multi-modal traffic data, and generating the future multi-modal traffic flow from the causal representation at a future moment as a prediction result; the present invention re-thinks the operation process of the multi-modal traffic system from a causal perspective, so that the prediction result is in accordance with the traffic operation;
2) The method of the present invention uses a variational auto-encoder to learn a causal Markov model, wherein a prior distribution models natural physical rules existing in a traffic system from historical conditional information; the variational posterior distribution extracts a causal representation of physical concepts from historical conditional information and multi-modal traffic data, and approximates a real posterior distribution of the data; the generation distribution is used to decompose the causal representation of physical concepts into multi-modal traffic flows; the present invention defines the joint distribution of the multi-modal traffic system based on the causal graph while matching the joint distribution by using a deep neural network; in this way, the interpretability of the model is effectively enhanced and the generalization ability of the model is significantly improved;
3) The method of the present invention re-deduces the lower bound of variational inference, uses the KL divergence to regularize the distance between the prior distribution and the variational posterior distribution, thereby enabling the prior distribution and the variational posterior distribution to sufficiently extract the useful information in the data while improving the modeling and prediction ability of the model;
4) Experimental results on the real datasets show that the method of the present invention possesses ideal performances; compared with the prior art, the prediction accuracy of the present invention is improved by about 10%, and the fluctuation caused by external factors is effectively resisted, greatly facilitating the development of a traffic management system.

### BRIEF DESCRIPTION OF THE DRAWINGS

FIG. 1 is a schematic diagram illustrating a multi-modal traffic distribution of a region in Beijing; FIG. 1(a) is a street division map of the region, FIG. 1(b) is a multi-modal traffic distribution map around a hospital in the region, and FIG. 1(c) is a multi-modal traffic distribution map around the Financial Street of the region;

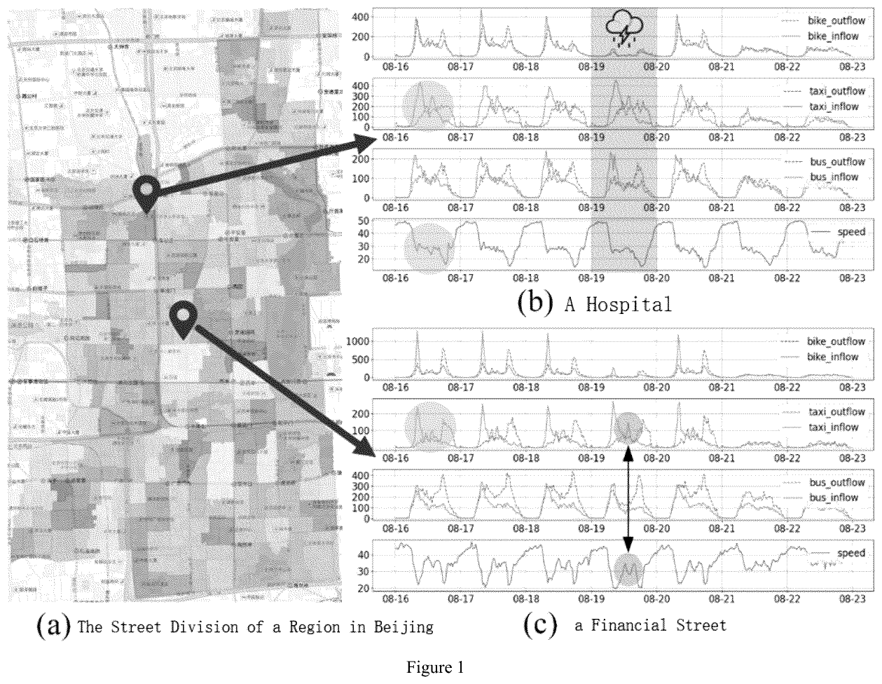

FIG. 2 is a casual graph illustrating a causal Markov process of the present invention;

FIG. 3 is a schematic diagram illustrating the multi-modal data prediction based on a causal Markov model of the present invention;

FIG. 4 is a schematic diagram illustrating a test result of the method of the present invention based on a traffic dataset in a region in Beijing;

FIG. 5 is a schematic diagram illustrating a comparison between prediction performances of the causal Markov model of the present invention before and after a prior network is deleted.

### DETAILED DESCRIPTION

Drawings and detailed embodiments are combined hereinafter to further elaborate the technical solution of the present invention.

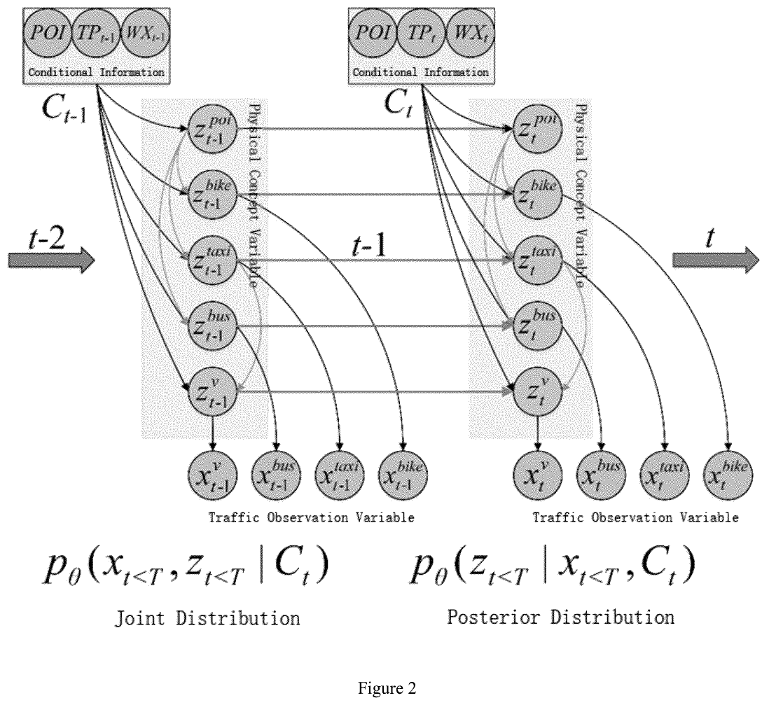

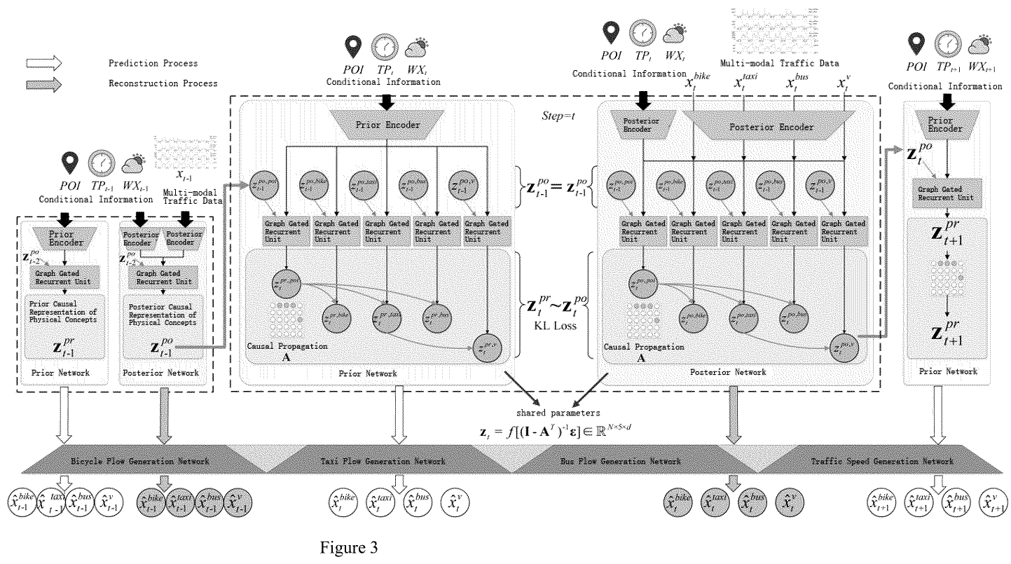

Due to the existence of spurious correlations among data in different conditions, excessively focusing on spatio-temporal correlations within these data may lead to unstable prediction results. Therefore, the present invention provides a multi-modal data prediction method based on a causal Markov model starting from the generation principle of multi-modal traffic data. As shown in FIG. 2, in the present invention, a multi-modal traffic data generation process is regarded as a causal Markov process, and time position information, regional POI (Point of Interest) information and weather information are regarded as conditional feature variables, a regional attraction factor, a bicycle demand factor, a taxi demand factor, a bus demand factor and a traffic speed factor are regarded as physical concept variables, and the bicycle traffic flow, the taxi traffic flow, the bus traffic flow and the regional speed are regarded as multi-modal traffic data observation variables. According to the present invention, a causal graph among these variables is constructed, and a joint distribution among the variables and a posterior distribution of the physical concepts are defined. To solve the joint distribution and posterior distribution of the causal Markov process, the present invention provides a network model based on a variational auto-encoder, which utilizes the joint distribution and variational posterior distribution of the neural network fitting data, as well as the real distribution of approximate data. As shown in FIG. 3, the causal Markov model comprises: (1) modeling a natural physical rule existing in a traffic system through inputting conditional variable data and learning a prior distribution of physical concepts by a prior network; (2) extracting a causal representation of physical concepts from data through inputting conditional variable data and multi-modal traffic data, and learning a variational posterior distribution of physical concepts by a posterior network; (3) enhancing a causal relationship among physical concepts through inputting a causal representation of physical concepts, and propagating a causal effect using a structural causal equation by a causal propagation module; (4) outputting a multi-modal traffic flow as a reconstruction and prediction result through inputting a causal representation of physical concepts by a generation network.

The following three steps are used to illustrate the implementation steps of the multi-modal data prediction method based on the causal Markov model and the effect verification of the method of the present invention:

Step 1: collecting regional data and multi-modal traffic data of a region to be studied, quantifying the data, constructing a causal graph of a causal Markov process among variables, and defining a joint distribution and a posterior distribution of physical concepts;

In an embodiment of the present invention, a region in Beijing is used as a research region, wherein a street map of the region is obtained and a regional POI is obtained therefrom, the weather data of the region is obtained from a weather station, and the shared bicycle order data, taxi order data, bus order data and road traffic speed data of the region are obtained from a traffic system; the order data is allocated to each sub-region of the research region to form multi-modal traffic flow data of each sub-region, and a mean value of the traffic speeds of vehicles on roads in each sub-region is calculated to form the sub-region speed data; the multi-modal traffic flow data and the regional speed data are collectively called the multi-modal traffic data;

In the present invention, the time position information, the regional POI information and the weather information are regarded as conditional feature variables, the regional attraction factor, the bicycle demand factor, the taxi demand factor, the bus demand factor and the traffic speed factor are regarded as physical concept variables, and the bicycle traffic flow, the taxi traffic flow, the bus traffic flow and the regional speed are regarded as multi-modal traffic data observation variables; according to the present invention, a causal graph among these variables is constructed, and a joint distribution among the variables and a posterior distribution of the physical concepts are defined; the joint distribution among the variables includes a prior distribution and a generation distribution, which are used to describe the generation process of the multi-modal traffic flow; the posterior distribution of the physical concept variables is used to describe the process of extracting a physical concept causal representation from the conditional information and multi-modal traffic data. It further comprising the steps 1.1-1.3:

Step 1.1: constructing a causal graph of the causal Markov process:

As shown in FIG. 2, in a time step T, the conditional feature variable Cₜ={TPₜ,POI, WXₜ} composed of the time position information TPₜ, the regional point of interest information POI and the weather information WXₜ may reflect an external state of the current system; regarding a regional attraction factor zₜ^{poi}, a bicycle demand factor zₜ^{bike}, a taxi demand factor zₜ^{taxi}, a bus demand factor zₜ^{bus} and a traffic speed factor zₜ^{v} as a physical concept variable zₜ={zₜ^{poi}, zₜ^{bike}, zₜ^{taxi}, zₜ^{bus}, zₜ^{v}}, which is considered a potential unobservable core impact factor in a traffic system for controlling the generation of a multi-modal traffic flow; combing the conditional feature variable Cₜ and the physical concept variable zₜ₋₁ in a previous step to generate a physical concept variable zₜ at the current moment; subsequently, generating a traffic observation variable xₜ={xₜ^{bike}, xₜ^{taxi}, xₜ^{bus}, xₜ^{v}} at the current moment from the physical concept variable {zₜ^{bike}, zₜ^{taxi}, zₜ^{bus} zₜ^{v}} of each mode, thereby generating a multi-modal traffic flow, wherein xₜ^{bike}, xₜ^{taxi}, xₜ^{bus} respectively represent the shared bicycle demand quantity, the taxi demand quantity and the bus demand quantity at the current moment, wherein xₜ^{v} represents the regional road traffic speed at the current moment; Extracting the conditional feature variable and the physical concept variable from historical data of a research region, wherein the time position information contains the sampled time period, and the regional point of interest information contains the number of various points of interest in the region; extracting the physical concept variables from the multi-modal traffic data of each sub-region; obtaining the bicycle demand factor of a sub-region from the shared bicycle order data of the sub-region, obtaining the taxi demand factor of a sub-region from the taxi order data of the sub-region, obtaining the bus demand factor of a sub-region from the bus order data of the sub-region, and obtaining the traffic speed factor from the sub-region traffic speed, wherein the regional attraction factor is primarily set according to the number of various points of interest in the region; Step 1.2: defining a joint distribution among variables, wherein a probability generation model of the causal Markov process may be represented by a joint distribution; according to the causal graph and the Markov property, decomposing the joint distribution into a prior distribution and a generation distribution; more specifically, defining the joint distribution as follows:

$${p}_{θ} ( {z}_{t < T} , {x}_{t < T} \vert {C}_{t < T} ) = {p}_{θ} ( {x}_{t < T} \vert {z}_{t < T} , {C}_{t < T} ) * {p}_{θ} ( {z}_{t < T} \vert {C}_{t < T} ) \qquad ( 1 )$$

$$= {\prod }_{t}^{T - 1} {p}_{θ} ( {z}_{t} \vert {z}_{t - 1} , {C}_{t} ) * {p}_{θ} ( {x}_{t} \vert {z}_{t} )$$

wherein p_{θ} represents the probability distribution, θ in formula (1) represents a system model parameter, and T represents a complete time sequence length, wherein the first item p_{θ}(zₜ|zₜ₋₁, Cₜ) represents a prior distribution of a physical concept variable, representing a natural physical rule existing in the traffic system, which is a prior knowledge that is not affected by the current observation variable, wherein the second item p_{θ}(xₜ|zₜ) represents a generation distribution, showing a process of generating observation data by an observation variable under the influence of a physical concept, wherein the generation distribution may be further decomposed into generation distributions of various traffic modes, which is defined as follows:

p_{θ}(xₜ|zₜ)=p_{θ}(xₜ^{bike}|zₜ^{bike})*p_{θ}(xₜ^{taxi}|zₜ^{taxi})*p_{θ}(xₜ^{bus}|zₜ^{bus})*p_{θ}(xₜ^{v}|zₜ^{v}) (2)

Step 1.3: defining a posterior distribution among variables, wherein the posterior distribution is used to describe the potential factors influencing the generation of observation data under the condition that the external environment and the observation variable of the current system are known, which is specifically defined as follows:

$${p}_{θ} ( {z}_{t < T} \vert {x}_{t < T} , {C}_{t < T} ) = {\prod }_{t}^{T - 1} {p}_{θ} ( {z}_{t} \vert {z}_{t - 1} , {x}_{t} , {C}_{t} ) \qquad ( 3 )$$

Step 2: building a causal Markov model by using a neural network, and solving the causal Markov process in step 1, wherein the main purpose is to infer a causal representation of a potential core physical concept from the external environment and the observation variable of the current system; this step further comprising the steps 2.1-2.3:

Due to the high difficulty of obtaining a real physical concept posterior distribution p_{θ}(z_{t<T}|x_{t<T}, C_{t<T}), the present invention calculates the variational posterior distribution q_{ϕ}(z_{t<T}|x_{t<T}, C_{t<T}) based on a variable Auto-Encoder (VAE) frame, thereby obtaining an approximately real posterior distribution, wherein ϕ represents a variational model parameter;

As shown in FIG. 3, the causal Markov model of the present invention comprises a prior network, a posterior network, a causal propagation module and a generation network; the prior network models a natural physical rule existing in a traffic system through inputting the conditional feature variable data and learns a prior distribution of a physical concept variable; the posterior network learns a variational posterior distribution of a physical concept variable through inputting the conditional feature variable data and multi-modal traffic data, and extracts a causal representation of a physical concept variable from the data; the causal propagation module uses a structural causal equation to propagate a causal effect and strengthens the causal relationship among physical concepts through inputting the causal representation of a physical concept variable; the generation network outputs the original multi-modal traffic flow as the reconstruction result through inputting the causal representation of a physical conceptual variable; the prior network and posterior network are used to solve and obtain the mean and variance; the present invention inputs the causal representation of physical concepts into the full connection layers, outputs the mean and variance of the multi-variate Gaussian distribution, and then obtains a corresponding probability distribution function;

As shown in FIG. 3, both the prior network and the posterior network comprise a graph-gated recurrent unit (GraphGRU) of each mode; the prior network and the posterior network share a causal propagation module; each element in a physical concept variable is a traffic mode; the method of the present invention comprises five traffic modes in total;

Step 2.1: establishing a posterior network by using the conditional information and multi-modal traffic data, wherein its purpose is to obtain an approximately real posterior distribution of a physical concept variable through learning a variational posterior distribution by using a neural network; as shown in FIG. 3, the posterior network comprising a graph gated recurrent unit (GraphGRU) and a causal propagation module;

The graph gated recurrent unit (GraphGRU): the generation process of the multi-modal traffic flow satisfies the Markov property, and the evolution of physical concept variables is an inherent driving force for the spatio-temporal dependence of the multi-modal traffic observation data; therefore, the present invention provides a graph gated recurrent unit to model the evolution process of the system states at the current moment and the previous moment, and capture the spatio-temporal dependency into potential physical concept variables, which is defined as follows:

sₜ^{po,i}=FC(Cₜ∥xₜⁱ)

rₜ^{po,i}=σ(Wᵣⁱå_{G}(sₜ^{po,i}∥zₜ₋₁^{po,i})+bᵣⁱ)

uₜ^{po,i}=σ(Wᵤⁱå_{G}(sₜ^{po,i}∥zₜ₋₁^{po,i})+bᵤⁱ)

\tilde{h}ₜ^{po,i}=tanh(Wₕⁱå_{G}(sₜ^{po,i}□zₜ₋₁^{po,i})+bₕⁱ)

zₜ^{po,i}=uₜ^{po,i}□zₜ₋₁^{po,i}+(1−uₜ^{po,i})□\tilde{h}ₜ^{po,i} (4)

wherein i∈{poi, bike, taxi, bus, v} represents different traffic modes, wherein t represents a t^{th} moment, namely, a collection time step, wherein sₜ^{po,i} represents an input feature of the i^{th} traffic mode, which is obtained by splicing the conditional information Cₜ ∈□^{N×C}^{ₑ} with the traffic data xₜⁱ∈□D^{N×c}^{ₜ} of the i^{th} traffic mode and then inputting the spliced traffic data into a full connection layer FCμ wherein ∥ represents a feature splicing operation, wherein N represents the number of regions, wherein c_{c} represents a feature dimension, wherein c, represents a traffic data dimension of the i^{th} mode, wherein the traffic data corresponding to the traffic mode of the regional attraction factor in the embodiment of the present invention is the total number of points of interest in sub-regions, wherein rₜ^{po,i} and uₜ^{po,i} respectively represent a reset gate and an update gate of the graph gated recurrent unit of the i^{th} traffic mode, wherein σ represents a sigmoid function, wherein å_{G} represents a graph convolution operation, wherein W, b represents a learnable parameter of the graph convolution, wherein subscripts r and u respectively represent a reset gate and an update gate, wherein the subscript h represents the structure for calculating candidate features, wherein zₜ^{po,i}∈□^{N×d} represents a posterior physical concept variable of the i^{th} traffic mode, wherein d represents a feature dimension, wherein \tilde{h}ₜ^{po,i} represents a candidate feature of the i^{th} traffic mode, wherein tanh represents a hyperbolic tangent function, wherein □ represents an element-by-element multiplication method, and wherein the superscript po represents a posterior network, wherein the graph convolution operation is defined as follows:

Wå_{G}(X)+b=(I+D^{-1/2}GD^{-1/2})XW+b (5)

wherein G∈□^{N×N} represents an adjacent matrix of a regional distance, wherein D represents a diagonal matrix Dᵢᵢ=ΣⱼGᵢⱼ of an adjacent matrix t wherein X represents the input data, and wherein I represents a cell matrix;

The causal propagation module: physical concept variables are naturally causally related, and therefore the semantic representation of physical concepts should also be causally related; the present invention provides a causal propagation module for propagating causal effects among variables based on a learned causal relationship, which is defined as follows:

f⁻¹(zₜ)=A^{T}f⁻¹(zₜ)+εzₜ=f[(I−A^{T})⁻¹ε]∈□^{N×5×d} (6)

wherein A∈□^{5×5} represents an adjacent matrix of the casual relationship of physical concept variables, wherein element Aᵢⱼ represents that the causal effect of variable i on variable j is Aᵢⱼ, wherein zₜ={zₜ^{poi}, zₜ^{bike}, zₜ^{taxi}, zₜ^{bus}, zₜ^{v}}represents a physical concept variable, wherein the superscript T represents a matrix transpose, wherein ε□N(0, I) represents the random Gaussian noise, wherein I∈□H^{5×5} represents a unit matrix t and wherein f(·) represents any reversible transformation functions, wherein the present invention uses an affine transformation function with parameters, which is defined as follows:

$$\begin{matrix}f ( x ) = α x + β \\ {f}^{- 1} ( x ) = \frac{f ( x ) - β}{α}\end{matrix} \qquad ( 7 )$$

wherein x represents an input vector of the function, wherein α,β∈□ is a learnable scalar parameter; as shown in FIG. 3, a connection edge existing between two variables represents a causal effect; in the present invention, the attraction factor of the region has a causal effect on the bicycle demand factor, the taxi demand factor and the bus demand factor, and the taxi demand factor has a causal effect on the traffic speed factor;

The generation of a variational posterior distribution: according to the present invention, a full connection layer is used to extract the mean μₜ^{po} and variance σₜ^{po} of the variational posterior distribution from the causal representation of the physical concepts output by the causal propagation module, and the generation process of the variational posterior distribution q_{ϕ}(zₜ|zₜ₋₁,xₜ,Cₜ) is as follows:

μₜ^{po}=FC_{μ}(zₜ^{po})

σₜ^{po}=FC_{σ}(zₜ^{po})

q_{ϕ}(zₜ|zₜ₋₁,xₜ,Cₜ)□N(μₜ^{po},σₜ^{po}) (8)

wherein FC_{μ} and FC_{σ} represent two full connection layers, wherein N(μₜ^{po}, σₜ^{po}) represents a Gaussian distribution with a mean value of μₜ^{po} and a variance of σₜ^{po}, wherein by sampling from the variational posterior distribution, a causal representation of the posterior physical concepts may be obtained;

Step 2.2: presently, the research on VAE considers a prior distribution as an independent standard Gaussian distribution, and due to the lack of inductive bias, this unsupervised causal representation learning method cannot ensure the identifiability of the causal representation; to improve the causal identifiability of the model, the present invention uses the conditional information to establish a prior network, whose purpose is to model the physical rules naturally existing in the system by the physical concepts themselves and use the learnable distribution to approximate the rules; the present invention supervises the prior network and the posterior network, which makes the prior network better match the natural rules of the physical concepts while helping the posterior network to identify the causal representation of the physical concepts; the structure of the prior network resembles that of the posterior network, each of which is composed of a graph gated recurrent unit and a causal propagation module;

The graph gated recurrent unit: the prior network merely inputs the conditional information of the current system, which is defined as follows:

sₜ^{pr,i}=FC(Cₜ∥xₜⁱ)

rₜ^{pr,i}=σ(Wᵣⁱå_{G}(sₜ^{pr,i}∥zₜ₋₁^{pr,j})+bᵣⁱ)

uₜ^{pr,i}=σ(Wᵤⁱå_{G}(sₜ^{pr,i}∥zₜ₋₁^{pr,j})+bᵤⁱ)

\tilde{h}ₜ^{pr,i}=tanh(Wₕⁱå_{G}(sₜ^{pr,i}□zₜ₋₁^{pr,j})+bₕⁱ)

zₜ^{pr,i}=uₜ^{pr,i}□zₜ₋₁^{pr,i}+(1−uₜ^{pr,i})□\tilde{h}ₜ^{pr,i} (4)

wherein the meaning of characters in the prior network is the same as that in the posterior network, wherein zₜ^{pr,i}∈□^{N×d} represents a prior physical concept variable of the i^{th} traffic mode at the t^{th} moment, wherein the superscript pr represents a prior network;

The causal propagation module: a prior network and a posterior network share a causal propagation module; in the present invention, the causal relationship is considered a stable natural phenomenon, which does not vary along the variation of time or space; therefore, a causal graph is globally shared, and the causal effect is propagated by using formula (6);

The generation of the prior distribution: the mean μₜ^{pr} and variance σₜ^{pr} of the prior distribution are extracted from the causal representation of the prior physical concepts output by the causal propagation module, and the generation process of the prior distribution p_{θ}(zₜ|zₜ₋₁, Cₜ) is as follows:

μₜ^{pr}=FC_{μ}(zₜ^{pr})

σₜ^{pr}=FC_{σ}(zₜ^{pr})

p_{θ}(zₜ|zₜ₋₁,xₜ,Cₜ)□N(μₜ^{pr},σₜ^{pr}) (10)

wherein FC_{μ} and FC_{σ} represent two full connection layers, wherein N(μₜ^{pr}, σₜ^{pr}) represents a Gaussian distribution with a mean value of μₜ^{pr} and a variance of σₜ^{pr}; by sampling from the prior distribution, the causal representation of the prior physical concepts may be obtained;

Step 2.3: the generation distribution at the moment t is shown in formula (2); the present invention uses two full connection layers to simulate the process of generating the multi-modal traffic observation data from physical concept variables; according to different types of the physical concept variables, the generation network generates traffic data observation variables corresponding to different modes;

The reconstruction process: as shown in FIG. 3, because the posterior network uses the multi-modal traffic data at the current moment as an input, when the posterior physical concept variables are used to generate the multi-modal traffic data, the output is a reconstruction result;

The prediction process: the prior network merely matches the prior distribution by using the conditional information at the current moment, which is irrelevant to the multi-modal traffic data at the current moment; therefore, when the prior physical concept variables are used to generate the multi-modal traffic data, the output is a prediction result;

Step 3: presetting a dataset D, learning the causal Markov model provided by the present invention, and then predicting the multi-modal traffic data of each sub-region in the research region by using the trained causal Markov model;

When inferring a causal representation, first, learning a variational posterior distribution of physical concepts from the historical conditional information and the multi-modal traffic data by a posterior network; modeling the natural physical rules existing in a traffic system from the historical conditional information, and learning a prior distribution of the physical concept variables by a prior network; subsequently, using KL divergence to regularize the distance between the variational posterior distribution and the prior distribution, thereby enabling the variational posterior distribution and the prior distribution to fully extract the useful information in the data; subsequently, sampling a causal representation of physical concepts from a variational posterior distribution; finally, reconstructing the input multi-modal traffic data by using a generation network and extracting a causal representation of the physical concept variables from the data using a variational auto-encoder; when predicting the multi-modal traffic data, first, using a prior network to infer a causal representation of physical concepts from the future conditional information at a future moment; finally, using the generation network to decode the causal representation of a future moment, and generating a multi-modal traffic flow at the future moment as the prediction result;

When training the model, the purpose of using the variational auto-encoder (VAE) is to minimize the KL divergence of the variational posterior distribution and the real posterior distribution of the data, wherein the derivation process is as follows:

$$\begin{matrix}{D}_{KL} [ {q}_{ϕ} ( {z}_{t < T} \vert {x}_{t < T} , {C}_{t < T} ) ‖ {p}_{θ} ( {z}_{t < T} \vert {x}_{t < T} , {C}_{t < T} ) ] = {E}_{{q}_{ϕ} ( {z}_{t < τ} \vert {x}_{t < T} , {C}_{t < T} )} [ log ( {q}_{ϕ} ( {z}_{t < τ} \vert {x}_{t < T} , {C}_{t < T} ) ) - log ( {p}_{θ} ( {z}_{t < T} \vert {x}_{t < T} , {C}_{t < T} ) ) ] \\ = {E}_{{q}_{ϕ} ( {z}_{t < τ} \vert {x}_{t < T} , {C}_{t < T} )} [ log ( {q}_{ϕ} ( {z}_{t < τ} \vert {x}_{t < T} , {C}_{t < T} ) ) - log ( {p}_{θ} ( {z}_{t < T} \vert {x}_{t < T} , {C}_{t < T} ) ) + log ( {p}_{θ} ( {x}_{t < T} \vert {C}_{t < T} ) ) ] \\ = {E}_{{q}_{ϕ} ( {z}_{t < τ} \vert {x}_{t < T} , {C}_{t < T} )} [ log ( {q}_{ϕ} ( {z}_{t < τ} \vert {x}_{t < T} , {C}_{t < T} ) ) - log ( {p}_{θ} ( {z}_{t < T} \vert {x}_{t < T} , {C}_{t < T} ) ) ] + log ( {p}_{θ} ( {x}_{t < T} \vert {C}_{t < T} ) )\end{matrix}$$

wherein D_{KL},[A∥B] represents the KL divergence of the distribution A and distribution B, wherein according to the aforesaid formula, the evidence lower bound of the variational auto-encoder may be further derived, and the learning process of the causal Markov model may be converted into the dataset D to maximize the variational lower bound, wherein the derivation process is as follows:

$$\begin{matrix}{E}_{D} [ log ( {p}_{θ} ( {x}_{t < T} \vert {C}_{t < T} ) ) ] = {E}_{D} [ {E}_{{q}_{ϕ} ( {z}_{t < T} \vert {x}_{t < T} , {C}_{t < T} )} [ log ( \frac{{p}_{θ} ( {x}_{t < T} , {z}_{t < T} \vert {C}_{t < T} )}{{q}_{ϕ} ( {z}_{t < T} \vert {x}_{t < T} , {C}_{t < T} )} ) ] + {D}_{K L} [ {q}_{ϕ} ‖ {p}_{θ} ] ] \\ = ELBO + {E}_{D} [ {D}_{K L} [ {q}_{ϕ} ‖ {p}_{θ} ] ] \\ \geq ELBO\end{matrix} \qquad ( 12 )$$

$$\begin{matrix}ELBO = {E}_{{q}_{ϕ} ( {z}_{t < τ} \vert {x}_{t < T} , {C}_{t < T} )} [ log ( \frac{{p}_{θ} ( {x}_{t < T} , {z}_{t < T} \vert {C}_{t < T} )}{{q}_{ϕ} ( {z}_{t < T} \vert {x}_{t < T} , {C}_{t < T} )} ) ] \\ = {E}_{{q}_{ϕ} ( {z}_{t < τ} \vert {x}_{t < T} , {C}_{t < T} )} [ log ( {p}_{θ} ( {x}_{t < T} \vert {z}_{t < T} , {C}_{t < T} ) ) - log ( \frac{log ( {q}_{ϕ} ( {z}_{t < T} \vert {x}_{t < T} , {C}_{t < T} ) )}{log ( {p}_{θ} ( {z}_{t < T} \vert {C}_{t < T} ) )} ) ] \\ = {E}_{{q}_{ϕ} ( {z}_{t < τ} \vert {x}_{t < T} , {C}_{t < T} )} [ log ( {p}_{θ} ( {x}_{t < T} \vert {z}_{t < T} , {C}_{t < T} ) ) ] ] - {D}_{K L} [ {q}_{ϕ} ( {z}_{t < T} \vert {x}_{t < T} , {C}_{t < T} ) ) ‖ log ( {p}_{θ} ( {z}_{t < T} \vert {C}_{t < T} ) ) ] \\ = {\sum }_{t = 1}^{T - 1} {E}_{{q}_{ϕ} ( {z}_{t} \vert {z}_{t - 1} , {x}_{t} , {C}_{t} )} [ log ( {p}_{θ} ( {x}_{t} \vert {z}_{t} ) ) ] - {D}_{K L} [ {q}_{ϕ} ( {z}_{t} \vert {z}_{t - 1} , {x}_{t} , {C}_{t} ) ‖ {p}_{θ} ( {z}_{t} \vert {z}_{t - 1} , {C}_{t} ) ]\end{matrix} \qquad ( 13 )$$

wherein the formula (13) is a loss function of the causal Markov model, wherein the first item E_{q}_{_{ϕ}}_{(z}_{ₜ}_{|z}_{ₜ₋₁}_{,x}_{ₜ}_{,C}_{ₜ}₎ [log(p_{θ}(xₜ|zₜ))] is a reconstruction loss used for representing the ability of the posterior network to extract the causal representation of the physical concepts, wherein the second item D_{KL} [q_{ϕ}(zₜ|zₜ₋₁, xₜ, Cₜ)∥p_{θ}(zₜ|zₜ₋₁, Cₜ)] is the KL divergence of the variational posterior distribution and the prior distribution, wherein allowing the prior network and the posterior network to supervise each other makes the prior network better match the natural rules of the physical concepts while helping the posterior network to identify the causal representation.

### Embodiment 1

Three real datasets, namely, the traffic flow dataset of an urban region in Beijing, the urban road speed dataset and the external environment dataset of the urban region are used in embodiment 1 of the present invention. The details of the dataset fields are shown in Table 1.

The traffic flow dataset of an urban region in Beijing contains order records for three traffic modes (bicycles, buses and taxis) from Jun. 1, 2021 to Dec. 31, 2021. The dataset contains the following information: pick-up time, drop-off time, pick-up longitude, pick-up latitude, drop-off longitude and drop-off latitude. The research region is divided into 175 non-overlapped sub-regions. The inflow and outflow of each traffic mode in all sub-regions are counted.

The urban road speed dataset contains speed records of vehicles on the main roads in the urban region from Jun. 1, 2021 to Dec. 31, 2021. The present invention uses the average speed of each road segment within each region to represent the regional speed every 30 minutes.

The external environment dataset of the urban region collects corresponding meteorological information, time position and POI data as the conditional information. The present invention divides the dataset at intervals of 30 minutes to obtain 11753 samples. The present invention uses the historical data in 3 hours to predict data for the next 30 minutes, wherein 80% of the data is used for training, 10% of the data is used for validating, and the rest is used for testing.

TABLE 1
Details of the Dataset Fields

| | |
|---|---|
| Dataset | The Traffic Data of an Urban Region in Beijing |
| Time Span | 2021 May 1-2021 Dec. 31 |

| | | |
|---|---|---|
| Order Quantity | Shared Bicycle Order | 75,626,065 |
| | Bus Order | 118,297,409 |
| | Taxi Order | 61,285,539 |
| | Speed Record | 738,970,573 |
| Meteorological | Temperature | [−20, 36] |
| Data | Wind Speed | [0, 66] |
| | Relative Humidity | [7, 100] |
| | Air Quality Index | [7, 500] |
| | Weather | Sunny, etc. |
| POI | Work Region | 802 |
| | Medical Service Region | 361 |
| | Educational Service Region | 241 |
| | Shopping Service Region | 32 |
| | Catering Service Region | 893 |

The present invention uses the Pytorch deep learning framework to perform the whole experiment on a workstation equipped with 24 GB memory Nvidia GeForce RTX 3090 GPU. The number of feature channels in the causal Markov model is set to be d=64, the batch size is set to be 64, and the learning rate is set to be 0.001. The present invention adopts the Adam optimizer and multi-step learning rate decay strategy. The channel for conditional information c_{c}=83, namely, the time position feature dimension is 56, the POI feature dimension is 5, and the weather feature dimension is 22. The time position and weather type adopt the one-hot encoding. The time position includes the day of the week, the time point of the day and whether it is a holiday. Except for the weather type, the Z-score standardization is applied to weather characteristics. For POI features, the total number of various POIs (including schools, hospitals, restaurants, office areas and shopping areas) in each sub-region is counted.

The present invention uses the root mean square error (RMSE) method, mean absolute error (MAE) method and mean absolute percentage error (MAPE) method to evaluate the performances of the model, which are defined as follows:

$$\begin{matrix}RMS E = \sqrt{\frac{1}{N} {\sum }_{i = 1}^{N} {( {\hat{X}}_{i} - {X}_{i} )}^{2}} \\ MAE = \frac{1}{N} {\sum }_{i = 1}^{N} \vert {\hat{X}}_{i} - {X}_{i} \vert \\ MAPE = \frac{1}{N} {\sum }_{i = 1}^{N} \frac{\vert {\hat{X}}_{i} - {X}_{i} \vert}{{X}_{i}}\end{matrix} \qquad ( 14 )$$

wherein \hat{X}ᵢ represents the predicted results, Xᵢ represents the true results of the data, and N represents the number of regions. To achieve consistency, the present invention deploys the same environment, loss function, traffic data and external factors (namely, time factors and weather information) for all models. In the present invention, the causal Markov model is compared with advanced methods for traffic flow prediction, and the final average results are shown in Table 2.

TABLE 2
Comparison of Quantitative Analysis Results between the Method of the Present
Invention and Other Methods Using a Dataset in an Urban Region in Beijing

| | A Dataset in an Urban Region in Beijing | | | | | | | | | | | |
|---|---|---|---|---|---|---|---|---|---|---|---|---|
| | Bike | | | Taxi | | | Bus | | | Speed | | |
| Model | MAE | RMSE | MAPE | MAE | RMSE | MAPE | MAE | RMSE | MAPE | MAE | RMSE | MAPE |
| HGCN | 5.6612 | 10.5526 | 23.2818% | 4.8627 | 8.5967 | 25.4933% | 7.5434 | 14.7726 | 22.4939% | 1.9353 | 2.8477 | 5.9296% |
| CCRNN | 5.3530 | 11.34111 | 21.1122% | 4.7581 | 8.7107 | 24.7395% | 6.6719 | 13.4522 | 20.2636% | 1.5560 | 2.5605 | 4.8916% |
| DMSTGCN | 5.2675 | 9.9759 | 21.5044% | 4.5879 | 7.9499 | 24.2042% | 6.3610 | 12.1108 | 19.9572% | 1.4072 | 2.2511 | 4.3595% |
| AGCRN | 5.0185 | 9.3577 | 20.3816% | 4.5611 | 7.8992 | 23.9883% | 6.5580 | 12.5084 | 19.9864% | 1.3678 | 2.1587 | 4.2762% |
| DGCRN | 4.9378 | 9.1436 | 20.3287% | 4.5360 | 7.8984 | 23.9846% | 6.4283 | 12.2228 | 19.6494% | 1.4154 | 2.2878 | 4.4090% |
| The present | 4.6418 | 8.5213 | 19.4286% | 4.4150 | 7.6262 | 23.5661% | 6.2450 | 11.8570 | 19.2033% | 1.2433 | 1.9943 | 3.8588% |
| invention | | | | | | | | | | | | |

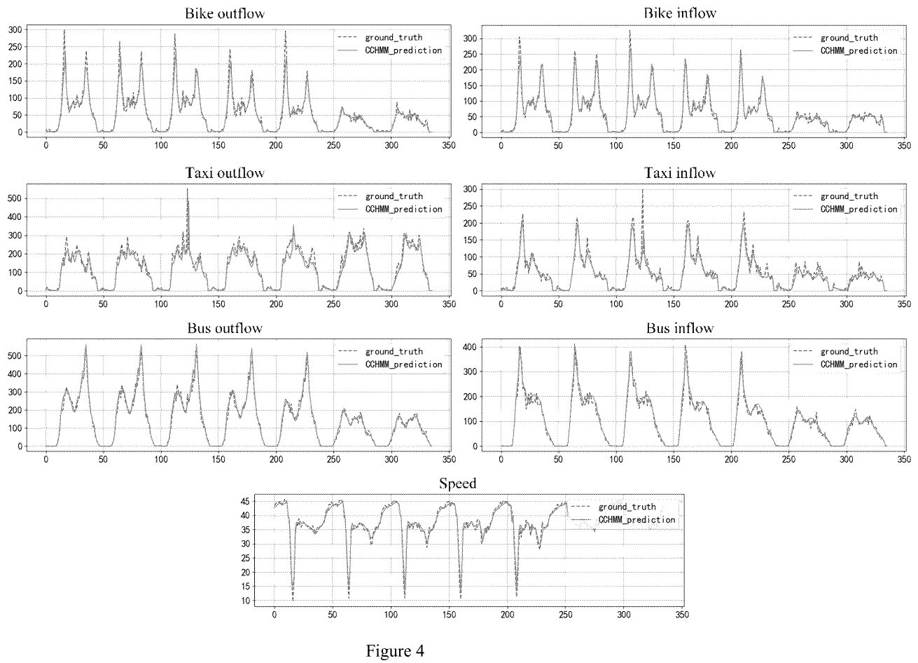

The present invention evaluates the performances of the mean absolute error (MAE) method, root mean square error (RMSE) method and mean absolute percentage error (MAPE) method. For the sake of fairness, the present invention takes the same conditional information, traffic flow, and traffic speed as inputs for all models. Table 2 shows the overall prediction performances of the average MAE, RMSE, and MAPE for three independent experiments, and the prediction results for each mode are shown in FIG. 4. The base model focuses on the adaptability of dynamically generated graph structures, while the model of the present invention focuses on modeling a causal relationship among potential semantic variables in a traffic system. Dynamic graph-based models such as the DGCRN perform better than adaptive graph-based models such as the AGCRN. Moreover, it can be seen from the Table that the model of the present invention consistently outperforms the base model. Especially in the speed prediction, the causal Markov model provided by the present invention improves the optimal results of all indicators by 10%.

To verify the effect of the key components of the causal Markov model used in the present invention, an ablation experiment is performed as follows:

For the posterior network and prior network, four variants are designed:
1) w/o GRU: this variant replaces a graph-gated recurrent unit with a graph convolution; the prior information of the latent variables is generated only by the conditional information, meaning that a long-term time-dependent relationship is abandoned;
2) w/o GCN: this variant deletes the GCN (Graph Neural Network) in the graph-gated recurrent unit, meaning that the space dependency is abandoned;
3) w/o condition: this variant deletes the conditional feature variables; removing the conditional feature variables is equivalent to removing the prior network, and a causal representation of physical concepts is directly generated from the multi-modal traffic data in the posterior network;
4) w/o prior: this variant deletes the prior network and saves the conditional feature variables; differing from variable 3, the causal representation of the physical concept variables is generated by the conditional information and the multi-modal traffic data;
5) w/o propagation: this variant deletes the causal propagation module, meaning that the mean and variance of the distribution is directly generated after the graph gated recurrent unit;

The performances of all variant models are listed in Table 3:

TABLE 3
Performance Comparison of All Variant Models

| | A Dataset of an Urban Region in Beijing | | | | | | | | | | | |
|---|---|---|---|---|---|---|---|---|---|---|---|---|
| Variant | Bike | | | Taxi | | | Bus | | | Speed | | |
| Model | MAE | RMSE | MAPE | MAE | RMSE | MAPE | MAE | RMSE | MAPE | MAE | RMSE | MAPE |
| w/o GRU | 10.4177 | 22.7940 | 39.8982% | 9.4037 | 17.6233 | 47.0230% | 10.7402 | 21.5010 | 28.9726% | 1.9551 | 3.0643 | 6.4062% |
| w/o GCN | 6.3110 | 12.6767 | 24.8612% | 5.2715 | 9.3825 | 27.1115% | 6.7583 | 12.9373 | 20.9419% | 1.4340 | 2.3319 | 4.5195% |
| w/o condition | 5.7693 | 11.1578 | 22.9648% | 5.5484 | 9.9345 | 28.4668% | 7.1146 | 13.8885 | 21.5514% | 1.4798 | 2.3978 | 4.6165% |
| w/o prior | 5.4904 | 10.6453 | 21.8347% | 5.0789 | 9.0566 | 26.1980% | 6.8861 | 13.2697 | 21.1046% | 1.4735 | 2.4378 | 4.5712% |
| w/o propagation | 5.1907 | 9.5034 | 21.6663% | 4.9019 | 8.4785 | 26.3348% | 6.6320 | 12.6021 | 20.4787% | 1.4398 | 2.3503 | 4.4778% |
| Complete Model | 4.6418 | 8.5213 | 19.4286% | 4.4150 | 7.6262 | 23.5661% | 6.2450 | 11.8570 | 19.2033% | 1.2433 | 1.9943 | 3.8588% |
| of the Present | | | | | | | | | | | | |
| Invention | | | | | | | | | | | | |

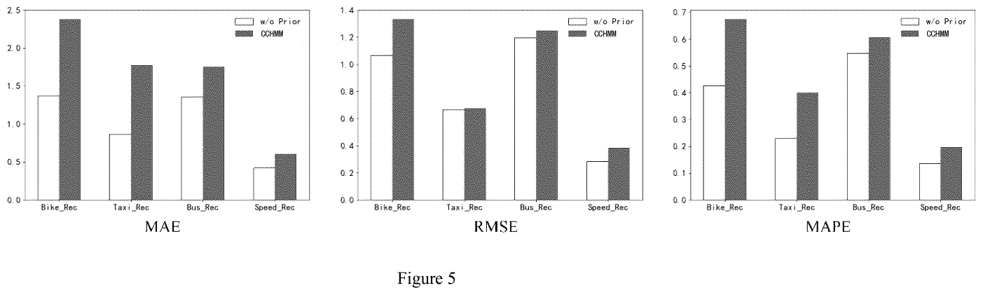

It can be seen from Table 3 that, due to the lack of spatio-temporal dependencies, the performances of variants 1 and 2 are the lowest. The performance of variable 3 indicates the necessity of conditional information. Meanwhile, a model lack of the conditional information may be degraded into a common sequence variational auto-encoder. The prior network is deleted from variant 4, whose purpose is to obtain a stability principle of physical concepts, and the function of the posterior network is to obtain separated causal representations from the observation data and the conditional information. Under the supervision of the prior network, a model collapse may easily occur, resulting in the failure of obtaining a stable and effective causal representation. As shown in FIG. 5, the reconstruction loss of variant 4 is typically lower than that of the causal Markov model, indicating that the model does not encode the useful information into the causal representation. The absence of the causal propagation module may cause a lack of causal relationship among causal variables such that the prediction performance is poor. In conclusion, all the components of the present invention are specially designed, significantly improving the final performance of the model.

1. A method of building a causal Markov model by using a neural network and solving the causal Markov process, wherein the causal Markov model comprises:
a prior network, a posterior network, a causal propagation module and a generation network, wherein the prior network learns the prior distribution of the physical concept variables in the traffic system by using the input conditional feature variables, wherein the posterior network learns the variational posterior distribution of the physical concept variables by using the input conditional feature variables and the multi-modal traffic data, and obtains an approximately real posterior distribution of the physical concept variables, wherein both the prior network and the posterior network comprising a graph gated recurrent unit and share a causal propagation module, wherein the causal propagation module inputs a causal representation of the physical concept variables, propagates the causal effect by using a learnable causal graph, and outputs a causal representation of the physical concept variables after the causal effect is propagated.

2. The method of claim 1, further comprising a step 1: collecting the regional data and traffic data of a research region, and constructing a causal graph of a causal Markov process; first, obtaining regional division, regional point of interest information, weather information and multi-modal traffic data of a research region, wherein the multi-modal traffic data includes the shared bicycle order data, taxi order data, bus order data and road traffic speed data; subsequently, taking the time position information, the regional point of interest information and the weather information as conditional feature variables, and taking the regional attraction factor, the bicycle demand factor, the taxi demand factor, the bus demand factor and the traffic speed factor as physical concept variables; constructing a causal graph of a causal Markov process, and taking the bicycle traffic flow, the taxi traffic flow, the bus traffic flow and the regional speed of the sub-regions as traffic data observation variables; generating physical concept variables at a current time step from conditional feature variables at a current time step and physical concept variables at a previous time step, and then predicting traffic data observation variables at the current time step; describing a generation process of multi-modal traffic data observation variables using a joint distribution of physical concept variables and traffic data observation variables, and decomposing the joint distribution into a prior distribution of physical concept variables and a generation distribution of traffic data observation variables; describing the process of extracting physical concept variables from conditional feature variables and multi-modal traffic data using the posterior distribution of physical concept variables; wherein the research region is divided into a plurality of sub-regions, and the order data is allocated to each sub-region to form the multi-modal traffic flow data of each sub-region, wherein the traffic speeds of vehicles on all roads in the sub-regions are averaged to form the sub-region speed data, and wherein the multi-modal traffic flow data and the regional speed data are collectively called the multi-modal traffic data.

3. The method of claim 2, wherein in step 1, the joint distribution is decomposed as follows:
$${p}_{θ} ( {z}_{t < T} , {x}_{t < T} \vert {C}_{t < T} ) = {\prod }_{t}^{T - 1} {p}_{θ} ( {z}_{t} \vert {z}_{t - 1} , {C}_{t} ) * {p}_{θ} ( {x}_{t} \vert {z}_{t} )$$
wherein T represents a time sequence length, wherein t represents a time step, wherein Cₜ, zₜ and xₜ respectively represent a conditional feature variable, a physical concept variable and a traffic data observation variable at the time step, wherein zₜ₋₁ represents a physical concept variable at the time step t-1, wherein p_{θ}(zₜ|zₜ₋₁, Cₜ) is a prior distribution of the physical concept variables, which represents a natural physical rule that exists in the traffic system itself, wherein p_{θ}(xₜ|zₜ) is a generation distribution of traffic data observation variables, which represents a process of generating observation data by observation variables under the influence of physical concept variables, wherein the generation distribution is further decomposed into the generation distribution of different traffic modes in the following:
p_{θ}(xₜ|zₜ)=p_{θ}(xₜ^{bike}|zₜ^{bike})*p_{θ}(xₜ^{taxi}|zₜ^{taxi})*p_{θ}(xₜ^{bus}|zₜ^{bus})*p_{θ}(xₜ^{v}|zₜ^{v})
wherein zₜ^{bike} represents a bicycle demand factor, zₜ^{taxi} represents a taxi demand factor, zₜ^{bus} represents a bus demand factor and zₜ^{v} represents a traffic speed factor, wherein xₜ^{bike}, xₜ^{taxi}, xₜ^{bus} respectively represent the shared bicycle traffic flow, the bus traffic flow and the bus traffic flow, wherein xₜ^{v} represents the regional road traffic speed.

4. The method of claim 2, wherein in step 1, the posterior distribution of the physical concept variables is defined as follows:
$${p}_{θ} ( {z}_{t < T} \vert {x}_{t < T} , {C}_{t < T} ) = {\prod }_{t}^{T - 1} {p}_{θ} ( {z}_{t} \vert {z}_{t - 1} , {x}_{t} , {C}_{t} ) ,$$
wherein T represents a time sequence length, wherein t represents a time step, wherein Cₜ, zₜ and xₜ respectively represent a conditional feature variable, a physical concept variable and a traffic data observation variable at the time step, wherein zₜ₋₁ represents a physical concept variable at the time step t-1.

5. The method of claim 1, in the posterior network, a graph gated recurrent unit is arranged for each traffic mode, each element in a physical concept variable is a traffic mode, and the modeling of the graph gated recurrent unit of the i^{th} traffic mode is as follows:
sₜ^{po,i}=FC(Cₜ∥xₜⁱ)
rₜ^{po,i}=σ(WᵣⁱÂ_{G}(sₜ^{po,i}∥zₜ₋₁^{po,i})+bᵣⁱ)
uₜ^{po,i}=σ(WᵤⁱÂ_{G}(sₜ^{po,i}∥zₜ₋₁^{po,i})+bᵤⁱ)
\tilde{h}ₜ^{po,i}=tanh(WₕⁱÂ_{G}(sₜ^{po,i}∥(rₜ^{po,i}⊙zₜ₋₁^{po,i})+bₕⁱ)
zₜ^{po,i}=uₜ^{po,i}⊙zₜ₋₁^{po,i}+(1−uₜ^{po,i})⊙\tilde{h}ₜ^{po,i} (4)
wherein t represents a moment t, wherein sₜ^{po,i} represents an input feature of the i^{th} traffic mode, which is obtained by splicing the conditional information Cₜ with the traffic data xₜⁱ of the i^{th} traffic mode and then inputting the spliced traffic data into a full connection layer FC,
wherein ∥ represents a feature splicing operation, wherein rₜ^{po,i} and uₜ^{po,i} respectively represent a reset gate and an update gate of the graph gated recurrent unit of the i^{th} traffic mode, wherein σ represents a sigmoid function, wherein tanh represents a hyperbolic tangent function, wherein Â_{G} represents a graph convolution operation, wherein W, b represents a learnable parameter of the graph convolution, wherein subscripts r and u respectively represent a reset gate and an update gate, wherein the subscript h represents the structure for calculating candidate features, wherein \tilde{h}ₜ^{po,i} represents a candidate feature of the i^{th} traffic mode, wherein zₜ^{po,i} represents a posterior physical concept variable of the i^{th} traffic mode, and wherein the superscript po represents a posterior network.

6. The method of claim 1, wherein in the prior network, a graph gated recurrent unit is arranged for each traffic mode, and the modeling of the graph gated recurrent unit of the i^{th} traffic mode is as follows:
sₜ^{pr,i}=FC(Cₜ∥xₜⁱ)
rₜ^{pr,i}=σ(WᵣⁱÂ_{G}(sₜ^{pr,i}∥zₜ₋₁^{pr,i})+bᵣⁱ)
uₜ^{pr,i}=σ(WᵤⁱÂ_{G}(sₜ^{pr,i}∥zₜ₋₁^{pr,i})+bᵤⁱ)
\tilde{h}ₜ^{pr,i}=tanh(WₕⁱÂ_{G}(sₜ^{pr,i}∥(rₜ^{pr,i}⊙zₜ₋₁^{pr,i})+bₕⁱ)
zₜ^{pr,i}=uₜ^{pr,i}⊙zₜ₋₁^{pr,i}+(1−uₜ^{pr,i})⊙\tilde{h}ₜ^{pr,i} (4)
wherein z_{pr,i}^{t} represents a prior physical concept variable of the i^{th} traffic mode, and wherein the superscript pr represents a prior network.

7. The method of claim 1, wherein the causal propagation module propagates the causal effect according to a learned causal relationship as follows:
f⁻¹(zₜ)=A^{T}f⁻¹(zₜ)+εzₜ=f[(I−A^{T})⁻¹ε]
wherein A represents an adjacent matrix of the casual relationship of physical concept variables, wherein T represents a transposition, zₜ represents a physical concept variable at a time step, wherein ε˜N(0,I) represents the random Gaussian noise, wherein I represents a unit matrix t and wherein f(·) represents any reversible transformation functions, wherein the regional attraction factor has a causal effect on the bicycle demand factor, the taxi demand factor and the bus demand factor, and wherein the taxi demand factor has a causal effect on the traffic speed factor.

8. The method of claim 7, wherein a transformation function set in the causal propagation module is an affine transformation function with parameters as follows:
$$\begin{matrix}f ( x ) = α x + β \\ {f}^{- 1} ( x ) = \frac{f ( x ) - β}{α}\end{matrix}$$
wherein x represents the input vector of the function, and α, β are learnable scalar parameters.

9. The method of claim 1, wherein the posterior network extracts the mean value μₜ^{po} and the variance σₜ^{po} of the variational posterior distribution from the causal representation of the physical concept variables output by the causal propagation module to obtain the variational posterior distribution q_{ϕ}(zₜ|zₜ₋₁, xₜ, Cₜ)˜N(μₜ^{po}, σₜ^{po}), and wherein the prior network extracts the mean value μₜ^{pr} and the variance σₜ^{pr} of the prior distribution from the causal representation of the physical concept variables output by the causal propagation module to obtain the prior distribution p_{θ}(zₜ|zₜ₋₁,C)˜N(μₜ^{pr}, σₜ^{pr}).

10. The method of claim 1, further comprising a step 3: collecting historical data in a research region to train the causal Markov model, and using the trained causal Markov model to predict the multi-modal traffic data in each sub-region of the research region, wherein the variational posterior distribution of the physical concept variables is output by the posterior network, thereby achieving a minimum KL divergence between the variational posterior distribution and the real posterior distribution for training the causal Markov model.

11. The method of claim 3, wherein the posterior distribution of the physical concept variables is defined as follows:
$${p}_{θ} ( {z}_{t < T} \vert {x}_{t < T} , {C}_{t < T} ) = {\prod }_{t}^{T - 1} {p}_{θ} ( {z}_{t} \vert {z}_{t - 1} , {x}_{t} , {C}_{t} ) ,$$
wherein T represents a time sequence length, wherein t represents a time step, wherein Cₜ, zₜ and xₜ respectively represent a conditional feature variable, a physical concept variable and a traffic data observation variable at the time step, wherein zₜ₋₁ represents a physical concept variable at the time step t-1.

12. The method of claim 5, wherein the causal propagation module propagates the causal effect according to a learned causal relationship as follows:
f⁻¹(zₜ)=A^{T}f⁻¹(zₜ)+εzₜ=f[(I−A^{T})⁻¹ε]
wherein A represents an adjacent matrix of the casual relationship of physical concept variables, wherein T represents a transposition, zₜ represents a physical concept variable at a time step, wherein ε˜N(0,I) represents the random Gaussian noise, wherein I represents a unit matrix t and wherein f(·) represents any reversible transformation functions, wherein the regional attraction factor has a causal effect on the bicycle demand factor, the taxi demand factor and the bus demand factor, and wherein the taxi demand factor has a causal effect on the traffic speed factor.

13. The method of claim 1, wherein the posterior network extracts the mean value μₜ^{po} and the variance σₜ^{po} of the variational posterior distribution from the causal representation of the physical concept variables output by the causal propagation module to obtain the variational posterior distribution q_{ϕ}(zₜ|zₜ₋₁, xₜ, C)˜N(μₜ^{po}, σₜ^{po}), and wherein the prior network extracts the mean value μₜ^{pr} and the variance σₜ^{pr} of the prior distribution from the causal representation of the physical concept variables output by the causal propagation module to obtain the prior distribution p_{θ}(zₜ zₜ₋₁,Cₜ)˜ N(μₜ^{pr}, σₜ^{pr}).

14. The method of claim 10, wherein in step 3, the variational posterior distribution of the physical concept variables is output by the posterior network, thereby achieving a minimum KL divergence between the variational posterior distribution and the real posterior distribution for training the causal Markov model.

15. A method of making a traffic optimized street comprising:
(a) collecting the regional data and traffic data of a research region nearby the street, and constructing a causal graph of a causal Markov process;
(i) obtaining regional division, regional point of interest information, weather information and multi-modal traffic data of a research region, wherein the multi-modal traffic data includes the shared bicycle order data, taxi order data, bus order data and road traffic speed data;
(ii) taking the time position information, the regional point of interest information and the weather information as conditional feature variables, and taking the regional attraction factor, the bicycle demand factor, the taxi demand factor, the bus demand factor and the traffic speed factor as physical concept variables;
(iii) constructing a causal graph of a causal Markov process, and taking the bicycle traffic flow, the taxi traffic flow, the bus traffic flow and the regional speed of the sub-regions as traffic data observation variables;
(iv) generating physical concept variables at a current time step from conditional feature variables at a current time step and physical concept variables at a previous time step, and then predicting traffic data observation variables at the current time step;
(v) describing a generation process of multi-modal traffic data observation variables using a joint distribution of physical concept variables and traffic data observation variables, and decomposing the joint distribution into a prior distribution of physical concept variables and a generation distribution of traffic data observation variables;
(vi) describing the process of extracting physical concept variables from conditional feature variables and multi-modal traffic data using the posterior distribution of physical concept variables;
(b) building a causal Markov model by using a neural network and solving the causal Markov process, wherein the causal Markov model comprises:
(i) a prior network, a posterior network, a causal propagation module and a generation network,
wherein the prior network learns the prior distribution of the physical concept variables in the traffic system by using the input conditional feature variables, wherein the posterior network learns the variational posterior distribution of the physical concept variables by using the input conditional feature variables and the multi-modal traffic data, and obtains an approximately real posterior distribution of the physical concept variables,
wherein both the prior network and the posterior network comprising a graph gated recurrent unit and share a causal propagation module,
wherein the causal propagation module inputs a causal representation of the physical concept variables, propagates the causal effect by using a learnable causal graph, and outputs a causal representation of the physical concept variables after the causal effect is propagated, and
wherein the generation network inputs a causal representation of physical concept variables and outputs corresponding multi-modal traffic data observation variables;
(c) collecting historical data in a research region to train the causal Markov model, and using the trained causal Markov model to optimize the traffic flow on the street.
